(19) United States
(12) Patent Application Publication
(10) Pub. No.: US 2003/0162900 A1
(43) Pub. Date: Aug. 28, 2003

(54) Impact-resistant modified polyamide molding compositions with higher melt viscosity and improved surface quality

(76) Inventors: Detlev Joachimi, Krefeld (DE); Peter Persigehl, Dusseldorf (DE); Helmut Schulte, Krefeld (DE)

Correspondence Address: BAYER POLYMERS LLC, 100 BAYER ROAD, PITTSBURGH, PA, 15205, US

(21) Appl. No.: 10/349,360

(22) Filed: Jan. 22, 2003

(30) Foreign Application Priority Data
Jan. 31, 2002 (DE) 10203971.2

(51) Int. Cl. C08F 8/30

(52) U.S. Cl. 525/178

(57) ABSTRACT

The present invention provides thermoplastic molding compositions produced from a mixture containing polyamide, fillers and reinforcing substances, difunctional or polyfunctional additives having a branching and/or polymer chain-extending action, impact modifiers, as well as other additives not having a branching and polymer chain-extending action.

### FIELD OF THE INVENTION

The present invention provides thermoplastic molding compositions produced from a mixture containing polyamide, fillers and reinforcing substances, difunctional or polyfunctional additives having a branching and/or polymer chain-extending action, impact modifiers, as well as other additives not having a branching and polymer chain-extending action.

### BACKGROUND OF THE INVENTION

Polyamide molding compositions are high-grade, thermoplastic materials that are characterized by high thermal stability, very good mechanical properties, high toughness values, good resistance to chemicals, and easy processability. The properties of polyamides can be significantly broadened by reinforcement with glass fibers, glass spheres, mineral fillers and mixtures thereof. An elastomer modification improves the impact strength of polyamides. Due to the large number of combination possibilities, new, tailor-made products are constantly being developed for special areas of use.

The range of applications of the polyamides includes fibers, films, hot-melt adhesives and molded parts for the electrical, construction, furniture and automotive industries. Strengthened polyamides are among the high-quality, engineering products that have replaced metal applications in various sectors.

Being partially crystalline polymers with a very high content of hydrogen bridges, polyamides have very low melt viscosities. Polyamides with a relative viscosity of 3 (measured in 1% m-cresol solution at 25° C.) have proved suitable for the production of molded parts by injection molding processes. Polyamides with higher viscosities are used for the production of films, profiled sections and pipes in the extrusion process and semi-finished products for thermoforming. Depending on the area of use, relative viscosities of 4 to 6 (measured in 1% m-cresol solution at 25° C.) are sufficient to obtain extrudates with adequate melt stabilities.

One possible way of increasing the viscosity is described in EP-A 0 685 528. Starting from thermoplastic polyamides, the viscosity is raised by addition of a diepoxide. The resulting polymers are, as described in DE-A 19 948 850, in particular suitable for the production of thermoplastic, thermoformable semi-finished products. The described materials are, however, not suitable for post-treatment (“dressing”) in the newly processed state (for example by cutting) because of high brittleness. In addition to the disadvantage of the brittleness in the unconditioned state, (which can lead to splintering during post-treatment) only sheets or molded parts of relatively poor surface quality may be obtained with the aforementioned materials. Such sheets or molded parts may not be suitable for applications that have to meet stringent requirements, such as regards the optical quality of the structural parts (lowest possible degree of roughness).

### SUMMARY OF THE INVENTION

The present invention, therefore, provides a polyamide for use in the production of films, profiled sections, pipes in the extrusion process and thermoplastic semi-finished products for thermoforming that is characterized by an improved processability after the extrusion process, as well as by an improved surface quality.

These and other advantages and benefits of the present invention will be apparent from the Detailed Description of the Invention herein below.

### DETAILED DESCRIPTION OF THE INVENTION

The present invention will now be described for purposes of illustration and not limitation.

It has been found that by the addition of rubber-elastic polymers to highly viscous, glass fiber-reinforced polyamide molding compositions, not only can the brittleness of the molded parts fabricated from the polyamide molding compositions according to the invention be reduced, but also a less rough surface is produced.

The present invention provides a polyamide molding composition containing,

A) 47 to 79 wt. % of a thermoplastic, partially crystalline polyamide,

B) 0 to 50 wt. % of reinforcing substances,

C) 0.1 to 4 wt. % of an additive having a branching and/or polymer chain-extending action (preferably a diepoxide),

D) 0.1 to 30 wt. % of a rubber-elastic polymer, and

E) 0.1 to 2 wt. % of processing additives, stabilisers and/or other conventional additives.

The polyamide molding compositions of the present invention possess not only the desired viscosity during the compounding, but can be very easily processed due to their broad processing window and the thermal stability of the melt, by the injection molding and gas injection processes, as well as by the extrusion and extrusion blow molding processes. Highly thermoplastic, semi-finished products that may very easily be thermoformed can be produced from the polyamide molding compositions of the present invention. The structural parts so obtained may be mechanically processed directly after production, by extrusion, extrusion blow molding or thermoforming processes, without brittle fractures occurring. The surface structure is very uniform.

Suitable as the thermoplastic polyamide of the molding compositions of the invention are partially crystalline polyamides (PA), preferred polyamides being PA 6, PA 66, PA 46, PA 610, PA 6/6T or partially crystalline copolyamides and/or mixtures based on these components. Particularly preferred are PA 6, PA 66 and copolyamides of PA 6 and PA 66.

Also suitable as the thermoplastic polyamide of the moulding compositions of the invention are partially crystalline polyamides, which may be produced starting from diamines and dicarboxylic acids and/or lactams with at least 5 ring members or corresponding amino acids.

Suitable starting products include aliphatic and/or aromatic dicarboxylic acids such as adipic acid, 2,2,4- and 2,4,4-trimethyladipic acid, azeleic acid, sebacic acid, isophthalic acid, terephthalic acid, aliphatic and/or aromatic diamines such as for example tetrramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bis-aminomethylcyclohexane, phenylenediamines, xylylenediamines, aminocarboxylic acids, such as aminocapropic acid, and/or the corresponding lactams. Copolyamides of several of the aforementioned monomers are also included.

Caprolactams are particularly preferred, with ε-caprolactam being most particularly preferred.

Preferred as reinforcing substances for the molding compositions of the present invention are commercially available glass fibers, carbon fibers, surface-treated fillers, etc. for polyamides, individually or as mixtures.

As fiber-shaped or particulate fillers there may be mentioned carbon fibers, glass fibers, glass spheres, glass flakes, amorphous silicic acid, calcium silicate, calcium metasilicate, magnesium carbonate, kaolin, chalk, powdered quartz, mica, barium sulfate and feldspar, which may be employed in amounts of up to 50 wt. %, in particular up to 40 wt. %.

As preferred fiber-shaped fillers there may be mentioned carbon fibers, aramide fibers and potassium titanate fibers, glass fibers in the form of E glass being particularly preferred. These may be used as rovings, chopped glass or ground glass fibers in the commercially available forms.

The fiber-shaped fillers may be pre-treated with a silane compound or other surface modifiers to improve the compatibility thereof with the thermoplastic materials.

Suitable silane compounds include those of the general formula (I)

(X—(CH₂)ₙ)ₖ—Si—(O—CₘH₂ₘ₊₁)₂₋ₖ (I)

wherein,

X represents

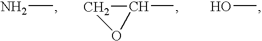

n represents a whole number from 2 to 10, preferably 3 or 4,

m represents a whole number from 1 to 5, preferably 1 or 2,

k represents a whole number from 1 to 3, preferably 1.

Preferred silane compounds are aminopropyltrimethoxysilane, aminobutyltrimethoxysilane, aminopropyltriethoxysilane, aminobutyltriethoxysilane, as well as the corresponding silanes that contain a glycidyl group as substituent X.

The silane compounds may be used in amounts of 0.05 to 5 wt. %, preferably 0.1 to 1.5 wt. % and in particular 0.25 to 1 wt. % (based on the reinforcing substance, B) for the surface containing.

Needle-shaped mineral fillers are also suitable in the present invention. The term “needle-shaped mineral fillers” within the context of the present invention is understood to refer to a mineral filler having a strongly pronounced needle-shaped character. Needle-shaped wollastonite may be mentioned by way of example. Preferably, the mineral has an L/D (length/diameter) ratio of 8:1 to 35:1, preferably 8:1 to 20:1. The mineral filler may optionally be pre-treated with the aforementioned silane compounds; the pre-treatment is, however, not absolutely necessary. In principle, wollastonites having a lower aspect ratio may also be used.

Kaolin, calcined kaolin, talcum and chalk may be mentioned as further fillers.

Suitable branching agents and/or chain extenders C) include, but are not limited to, low molecular weight and oligomeric compounds that contain at least two reactive groups that can react with primary and/or secondary amino groups and/or amide groups and/or carboxylic acid groups. Reactive groups may, for example, be isocyanates, optionally blocked, epoxides, maleic anhydride, oxazolines, oxazines, oxazolones, etc. Preferred are diepoxides based on diglycidyl ether (bisphenol and epichlorohydrin), based on amine peroxide resin (aniline and epichlorohydrin) or based on diglycidyl esters (cycloaliphatic dicarboxylic acids and epichlorohydrin), individually or as mixtures, as well as 2,2-bis-[p-hydroxyphenyl]-propane diglycidyl ether, bis-[p-(N-methyl-N-2,3-epoxypropylamino)-phenyl]-methane. Particularly preferred are glycidyl ethers, and most particularly preferred is bisphenol A diglycidyl ether.

The following are suitable as branching agents/chain extenders:

1. Polyglycidyl ethers or poly-(β-methylglycidyl) ethers obtained by reacting a compound containing at least two free alcoholic hydroxy groups and/or phenolic hydroxy groups and a suitably substituted epichlorohydrin under alkaline conditions, or in the presence of an acid catalyst followed by treatment with alkali.

Ethers of this type may be derived from acyclic alcohols, such as ethylene glycol, diethylene glycol and higher poly-(oxyethylene) glycols, propane-1,2-diol, or poly-(oxypropylene) glycols, propane-1,3-diol, butane-1,4-diol, poly-(oxytetramethylene) glycols, pentane-1 ,5-diol, hexane-1,6-diol, hexane-2,4,6-triol, glycerol, 1,1,1-trimethylpropane, bistrimethylolpropane, pentaerythritol, sorbitol, as well as from polyepichlorodydrins.

The ethers may, however, also be derived from cycloaliphatic alcohols such as 1,3-dihydroxycyclohexane or 1,4-dihydroxycyclohexane, bis-(4-hydroxycyclohexyl)methane, 2,2-bis-(4-hydroxycyclohexyl)propane or 1,1 -bis-(hydroxymethyl)cyclohex-3-ene or they contain aromatic nuclei such as N,N-bis-(2-hydroxyethyl)aniline or p,p′-bis-(2-hydroxyethylamino) diphenylmethane.

The epoxide compounds may also be derived from mononuclear phenols such as from resorcinol or hydroquninone; alternatively, the epoxide compound may be based on polynuclear phenols such as on bis-(4-hydroxyphenyl)methane, 2,2-bis-(4-hydroxyphenyl)propane, 2,2-bis-(3,5-dibromhydroxyphenyl)propane, 4,4′-dihydroxydiphenylsulfone or on condensation products of phenols with formaldehyde obtained under acidic conditions, such as phenol novolaks.

2. Poly-(N-glycidyl) compounds obtained by dehydrochlorination of the reaction products of epichlorohydrin with amines that contain at least two amino hydrogen atoms. These amines may be aniline, toluidine, n-butylamine, bis-(4-aminophenyl)methane, m-xylylenediamine or bis-(4-methylaminophenyl)methane, but also include N,N,O-triglycidyl-m-aminophenyl or N,N,O-triglycidyl-p-aminophenol.

The poly-(N-glycidyl) compounds also include N,N′-diglycidyl derivatives of cycloalkylene ureas, such as ethylene urea or 1,3-propylene urea, and N,N′-diglycidyl derivatives of hydantoins, such as of 5,5-dimethyl-hydantoin.

3. Poly-(S-glycidyl) compounds such as di-S-glycidyl derivatives that are derived from dithiols such as ethane-1,2-dithiol or bis-(4-mercaptomethylphenyl) ether.

As component D), the molding compositions according to the invention may contain 0.1 to 30 wt. %, preferably 1 to 25 wt. %, particularly preferably 5.1 to 20 wt. % of rubber-elastic polymers (also often termed impact modifiers, elastomers or rubbers).

In general, the rubber-elastic polymers may be copolymers that are preferably built up from at least two of the following monomers: ethylene, propylene, butadiene, isobutene, isoprene, chloroprene, vinyl acetate, styrene, acrylonitrile and acrylic acid or methacrylic acid esters with 1 to 18 carbon atoms in the alcohol component. Such polymers are described in Houben-Weyl, Methoden der organischen Chemie, Vol. 14/1 (Georg Thieme-Verlag, Stuttgart 1961), pp. 392 to 406. Some preferred types of such elastomers are mentioned hereinafter.

Preferred types of such elastomers are the so-called ethylene-propylene (EPM) or ethylene-propylene-diene (EPDM) rubbers. In practice, EPM rubbers generally no longer contain any double bonds, while EPDM rubbers may contain 1 to 20 double bonds per 100 carbon atoms.

As diene monomers for EPDM rubbers, there may be mentioned by way of example, conjugated dienes such as isoprene and butadiene, non-conjugated dienes with 5 to 25 carbon atoms such as penta-1,4-diene, hexa-1,4-diene, hexa-1,5-diene, 2,5-dimethylhexa-1,5-diene and 2,5-dimethylocta-1,4-diene, cyclic dienes such as cyclopentadiene, cyclohexadienes, cyclooctadienes and dicylcopentadiene, as well as alkenyl norbornenes such as 5-ethylidene-2-norbornene, 5-butylidene-2-norbornene, 2-methallyl-5-norbornene, 2-isopropenyl-5-norbornene and tricyclodienes such as 3-methyltricyclo(5.2.1.0.2.6)-3,8-decadiene or mixtures thereof. Hexa-1,5-diene, 5-ethylidene norbornene and dicyclopentadiene are preferred. The diene content of the EPDM rubbers is preferably 0.5 to 50 wt. %, in particular 1 to 8 wt. %, based on the total weight of the rubber.

EPM and EPDM rubbers may preferably also be grafted with reactive carboxylic acids or derivatives thereof. There may be mentioned here by way of example acrylic acid, methacrylic acid and their derivatives, e.g. glycidyl(meth)acrylate, as well as maleic anhydride.

A further group of preferred rubbers include copolymers of ethylene with acrylic acid and/or methacrylic acid and/or the esters of these acids. In addition, the rubbers may also contain dicarboxylic acids such as maleic acid and fumaric acid or derivatives of these acids, for example, esters and anhydrides, and/or monomers containing epoxy groups. These dicarboxylic acid derivatives or epoxy group-containing monomers may preferably be incorporated into the rubber by addition, to the monomer mixture, of monomers containing dicarboxylic acid groups and/or epoxy groups of the general formula (II) or (III) or (IV) or (VV)

R¹C(COOR²)═C(COOR³)R⁴ (II)

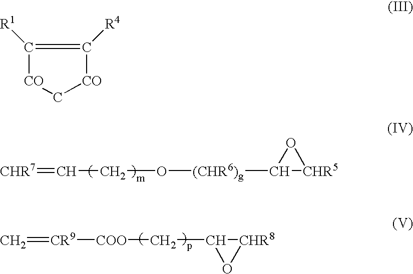

in which R¹ to R⁹ represent hydrogen or C₁-C₆-alkyl groups, m represents a whole number from 0 to 20, g represents a whole number from 0 to 10 and p represents a whole number from 0 to 5.

Preferably, the radicals R¹ to R⁹ represent hydrogen, m represents 0 or 1 and g represents 1. The corresponding compounds are maleic acid, fumaric acid, maleic anhydride, allyl glycidyl ether and vinyl glycidyl ether.

Preferred compounds of the formulae (II), (III) and (V) are maleic acid, maleic anhydride and epoxy group-containing esters of acrylic acid and/or methacrylic acid such as glycidyl acrylate, glycidyl methacrylate and the esters with tertiary alcohols, such as t-butyl acrylate. Although the latter have no free carboxyl groups, their behavior is similar to that of the free acids and they are therefore described as monomers having latent carboxyl groups.

Preferably, the copolymers may consist of 50 to 98 wt. % of ethylene, 0.1 to 20 wt. % of epoxy group-containing monomers and/or methacrylic acid and/or acid anhydride group-containing monomers, as well as the residual amount of (meth)acrylic acid esters.

Particularly preferred are copolymers of

50 to 98 wt. %, in particular 55 to 95 wt. % of ethylene,

0.1 to 40 wt. %, in particular 0.3 to 20 wt. % of glycidyl acrylate and/or glycidyl methacrylate, (meth)acrylic acid and/or maleic anhydride, and

1 to 45 wt. %, in particular 10 to 40 wt. % of n-butyl acrylate and/or 2-ethylhexyl acrylate.

Further preferred esters of acrylic acid and/or methacrylic acid are the methyl, ethyl, propyl and i-butyl and t-butyl esters. In addition, vinyl esters and vinyl ethers may also be used as comonomers.

The aforementioned ethylene copolymers may be produced by methods known in the art, preferably by random copolymerization under high pressure and elevated temperature. Corresponding processes are generally known.

Preferred elastomers also include emulsion polymers, described for example by Blackley in the monograph “Emulsion Polymerization”. The emulsifiers and catalysts that may be used are known in the art.

In principle, homogeneously structured elastomers or those having a shell structure may be employed. The shell-type structure is determined by the sequence of addition of the individual monomers; also, the morphology of the polymers is influenced by this sequence of addition.

Acrylates such as n-butyl acrylate and 2-ethylhexyl acrylate, corresponding methacrylates, butadiene and isoprene, as well as mixtures thereof, may be mentioned here by way of example as monomers for the production of the rubber part of the elastomers. Those monomers may be copolymerized with further monomers, for example, with styrene, acrylonitrile, vinyl ethers and further acrylates or methacrylates, such as methyl methacrylate, methyl acrylate, ethyl acrylate and propyl acrylate.

The flexible or rubber phase (with a glass transition temperature of below 0° C.) of the elastomers may form the core, the outer cover or a middle shell (in the case of elastomers with a more than double-shell structure); with multi-shell elastomers several shells may also have a rubber phase.

Where one or more rigid components (with glass transition temperatures of more than 20° C.), apart from the rubber phase, are involved in the structure of the elastomer, these are generally produced by polymerization of styrene, acrylonitrile, methacrylonitrile, α-methylstyrene, p-methylstyrene, acrylic acid esters and methacrylic acid esters such as methyl acrylate, ethyl acrylate and methyl methacrylate as principal monomers. In addition, minor amounts of further comonomers may also be used in this connection.

In some cases, it has proven advantageous to use emulsion polymers that contain reactive groups on the surface. Such groups include epoxy, carboxyl, latent carboxyl, amino or amide groups, as well as functional groups that may be incorporated by the co-use of monomers of the formula (VI)

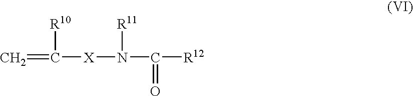

wherein

R¹⁰ represents hydrogen or a C₁-C₄-alkyl group,

R¹¹ represents hydrogen, a C₁-C₈-alkyl group or an aryl group, in particular phenyl,

R¹² represents hydrogen, a C₁-C₁₀-alkyl group, a C₆-C₁₂-aryl group or —OR¹³,

R¹³ represents a C₁-C₈-alkyl group or C₆-C₁₂-aryl group, which may optionally be substituted with O-containing or N-containing groups,

X represents a chemical bond, a C₁-C₁₀-alkylene or C₆-C₁₂-arylene group or

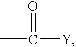

Y represents O-Z or HN-Z, and

Z represents a C₁-C₁₀-alkylene or C₆-C₁₂-arylene group.

The graft monomers described in P-A 208 187 may also be suitable for introducing reactive groups on the surface.

As further examples, there may also be mentioned acrylamide, methacrylamide and substituted esters of acrylic acid or methacrylic acid such as (N-t-butylamino)-ethyl methacrylate, (N,N-dimethylamino)ethyl acrylate, (N,N-dimethylamino)methyl acrylate and (N,N-diethylamino)ethyl acrylate.

Furthermore, the particles of the rubber phase may be crosslinked. Monomers acting as crosslinking agents include, but are not limited to, buta-1,3-diene, divinylbenzene, diallyl phthalate and dihydrodicyclopentadienyl acrylate, as well as the compounds described in EP-A 50 265.

Moreover, so-called graft-linking monomers may also be used, i.e. monomers with two or more polymerizable double bonds that react at different rates during the polymerization. Preferably those compounds are used in which at least one reactive group polymerizes at roughly the same rate as the remaining monomers, while the other reactive group (or reactive groups) polymerizes substantially more slowly. The different polymerization rates result in a certain proportion of unsaturated double bonds in the rubber. If a further phase is then grafted onto such a rubber, the double bonds present in the rubber react at least partially with the graft monomers to form chemical bonds, i.e. the grafted-on phase is at least partially linked via chemical bonds to the graft base.

Examples of such graft-linking monomers are those containing ally groups, in particular allyl esters of ethylenically unsaturated carboxylic acids such as allyl acrylate, allyl methacrylate, diallyl maleate, diallyl fumarate, diallyl itaconate and the corresponding monoallyl compounds of those dicarboxylic acids. In addition, there is a large number of suitable graft-linking monomers, further details of which may be found for example in U.S. Pat. No. 4,148,846.

In general, the proportion of these crosslinking monomers in the impact-resistant modifying polymer is up to 5 wt. %, preferably no more than 3 wt. %, based on the impact-resistant modifying polymer.

Some preferred emulsion polymers are listed hereinbelow. Graft polymers with a core and at least one outer shell that have the following structure should first of all be mentioned here:

| Type | Monomers for the Core | Monomers for the Cover |
|---|---|---|
| I | buta-1,3-diene, isoprene, n- | styrene, acrylonitrile, methyl |
| | butyl acrylate, ethyl | methacrylate |
| | hexacrylate or mixtures | |
| | thereof | |
| II | as I, but with the co-use of | as I |
| | crosslinking agents | |
| III | as I or II | n-butyl acrylate, ethyl acrylate, |
| | | methyl acrylate, buta-1,3-diene, |
| | | isoprene, ethylhexyl acrylate |
| IV | as I or II | as I or III, but with the co-use of |
| | | monomers containing reactive |
| | | groups as described herein |
| V | styrene, acrylonitrile, methyl | first cover of monomers as |
| | methacrylate or their mixtures | described under I and II for the |
| | | core, second cover as described |
| | | under I or IV for the cover |

These graft polymers, in particular ABS polymers and/or ASA polymers in amounts of up to 40 wt. %, may preferably be used for the impact-resistant modification of PBT, optionally mixed with up to 40 wt. % of polyethylene terephthalate. Corresponding blend products may be obtained under the trade mark Ultradur®s (formerly Utrablend®S of BASF AG). ABS/ASA mixtures with polycarbonates are commercially available under the trade name Terblend® (BASF AG).

Instead of graft polymers with a multi-shell structure, homogeneous elastomers, i.e. single-shell elastomers of buta-1,3-diene, isoprene and n-butyl acrylate or their copolymers may be used. These products too can be produced by the co-use of crosslinking monomers or monomers containing reactive groups.

Examples of preferred emulsion polymers include, n-butyl acrylate/(meth)acrylic acid copolymers, n-butyl acrylate/glycidyl acrylate copolymers or n-butyl acrylate/glycidyl methacrylate copolymers, graft polymers with an inner core of n-butyl acrylate or based on butadiene and an outer cover of the aforementioned copolymers and copolymers of ethylene with comonomers that provide reactive groups.

The described elastomers may also be produced by other conventional methods, for example by suspension polymerization.

Silicone rubbers, as described in DE-A 37 25 576, EP-A 235 690, DE-A 38 00 603 and EP-A 319 290, are also preferred.

As will be apparent to those skilled in the art, mixtures of the types of rubbers listed above may also be employed.

As component E), the thermoplastic molding compositions according to the invention may contain conventional processing auxiliary substances such as stabilizers, antioxidants, agents to counteract thermal decomposition and decomposition caused by ultraviolet light, lubricants and mold release agents, colorants such as dyes and pigments, nucleating agents, plasticizers, etc.

As examples of antioxidants and thermal stabilizers, there may be mentioned, sterically hindered phenols and/or phosphites, hydroquinones, aromatic secondary amines such as diphenylamines, various substituted members of these groups and mixtures thereof, in concentrations up to 1 wt. %, based on the weight of the thermoplastic molding compositions.

As UV stabilizers, which are generally used in amounts of up to 2 wt. %, based on the molding composition, there may be mentioned various substituted resorcinols, salicylates, benzotriazoles and benzophenones.

Inorganic pigments such as titanium dioxide, ultramarine blue, iron oxide and carbon black, and furthermore organic pigments such as phthalocyanines, quinacridones, perylenes, as well as dyes such as nigrosine and anthraquinones, may be added as colorants.

As nucleating agents, there may be added sodium phenyl phosphinate, aluminum oxide, silicon dioxide, as well as, preferably, talcum.

Lubricants and mold release agents, which may be used in amounts of up to 1 wt. %, are preferably long-chain fatty acids (e.g. stearic acid or behenic acid), their salts (e.g. Ca or Zn stearate), as well as amide derivatives (e.g. ethylene-bis-stearylamide) or montan waxes (mixtures of straight-chain, saturated carboxylic acids with chain lengths of 28 to 32 C atoms) and low molecular weight polyethylene and polypropylene waxes.

As examples of plasticizers, there may be mentioned dioctyl phthalate, dibenzyl phthalate, butylbenzyl phthalate, hydrocarbon oils and N-(n-butyl)benzenesulfonamide. Examples include, but are not limited to, polytetrafluoroethylene (PTFE), tetrafluoroethylene-hexafluoropropylene copolymers or tetrafluoroethylene copolymers with relatively small proportions (as a rule up to 50 wt. %) of copolymerizable ethylenically unsaturated monomers. These are described by Schildknecht in “Vinyl and Related Polymers”, Wiley Publishers, 1952, pp. 484 to 494 and by Wall in “Fluoropolymers” (Wiley Interscience, 1972).

The production of the compositions according to the invention may be carried out, for example, on single-shaft or twin-shaft extruders or kneaders. The melt temperature is governed by the polyamides that are used and may be between 220° C. and 350° C.

The invention is further illustrated but is not intended to be limited by the following examples in which all parts and percentages are by weight unless otherwise specified.

### EXAMPLES

The following products were used in the examples:

PA6, Durethan B29 from Bayer AG, relative viscosity ηᵣₑₗ=3.0, measured in 0.5 wt. % solution in m-cresol;

Diepoxide, Rütapox 0162 from Bakelit AG;

Glass fibers, Bayer AG, CS 7928;

Modifier, Exxelor VA1801 from EXXON;

Heat stabilizer (copper iodide/potassium halide type);

Montan ester wax; and

Carbon black.

The starting substances were compounded in a Werner & Pfleiderer twin-screw extruder (150 revs/min; 10 kg/hour) at 280° C., extruded in a water bath and granulated. The granular material obtained was in each case dried for 4 hours at ca. 70° C. in a vacuum drying cabinet.

The production of the sheet semi-finished articles required for the thermoforming was carried out in an extrusion device using the granular material produced according to the examples. The polymer granules were extruded through a wide-slit nozzle through a degassing extruder and drawn through a calender machine and calibrated. Sheets, 3 mm thick and 800 mm wide, were produced in this way, which were cut into ca. 2000 mm long sections.

The sheet semi-finished products were then thermoformed in an Illig thermoforming device (Illig UA 100 g thermoformer). An aluminum Porsche mold, also from Illig, heated to a temperature of 90° C. was used as thermoforming mold, which enabled regions with high degrees of stretching and regions with low degrees of stretching to be formed next to each another. The surface roughnesses in the regions of high and low stretching were compared and are reported in Table I.

TABLE I

| | | Example 1 | Example 2 |
|---|---|---|---|
| PA6 | wt. % | 76.5 | 83.45 |
| Glass fibers | wt. % | 15.0 | 15.0 |
| Die oxide | wt. % | 0.6 | 0.65 |
| Modifier | wt. % | 7.0 | |
| Wax, carbon black, | wt. % | 0.9 | 0.9 |
| stabilizer | | | |
| Notch-impact strength ⁽¹⁾ | kJ/m² | 15 | <10 |
| MVR ⁽²⁾ | cm³/10 | 3.0 | 3.0 |
| | min | | |
| Surface roughness (Ra) ^{(3),} | | 6.13 | 10.40 |
| high Stretching | | internal ⁽⁴⁾ | internal ⁽⁴⁾ |
| | μm | 10.69 | 17.24 |
| | | external ⁽⁵⁾ | external ⁽⁵⁾ |
| Surface roughness (Ra) ^{(3),} | | 6.51 | 6.68 internal ⁽⁴⁾ |
| low Stretching | | internal ⁽⁴⁾ | |
| | μm | 8.89 | 11.66 |
| | external ⁽⁵⁾ | external ⁽⁵⁾ | |
| Processing behavior when | | Good; | Poor; brittle, |
| trimmed (with band saw) | | smooth cut | splintered |
| | | edges | cut edges |

⁽¹⁾ according to ISO 180-1A, 23° C., in the freshly injection molded state,
⁽²⁾ according to ISO 1133, 270° C., 5 kg,
⁽³⁾ mean value, measured with a Tenco Alphastep 500 layer thickness measuring device,
⁽⁴⁾ internal = surface with mold contact,
⁽⁵⁾ external = surface without mold contact.

Although the invention has been described in detail in the foregoing for the purpose of illustration, it is to be understood that such detail is solely for that purpose. It will be apparent that variations can be made thereto by those skilled in the art without departing from the spirit of the invention. The scope of the present invention is to be measured by the appended claims.

What is claimed is:

1. A molding composition containing
47 to 79 wt. % of a thermoplastic partially crystalline polyamide;
0 to 50 wt. % of reinforcing substances;
0.1 to 4 wt. % of an additive having a branching and/or polymer chain-extending action;
0.1 to 30 wt. % of a rubber-elastic polymer; and
0.1 to 2 wt. % of processing additives.

2. The molding composition according to claim 1, wherein the thermoplastic, partially crystalline polyamide is at least one member selected from the group consisting of polyamide 6, polyamide 66, polyamide 46, polyamide 610, polyamide 6/6T or partially crystalline copolyamide based on one of those polyamides, and mixtures thereof.

3. The molding composition according to one of the preceding claims, wherein the reinforcing substance is at least one member selected from the group consisting of glass fibers, carbon fibers, mineral fibers or mixtures thereof and particulate, mineral fillers.

4. The molding composition according to one of claims 1 or 2, wherein in the additive having a branching and/or polymer chain extending action is at least one member selected from the group consisting of diepoxides based on diglycidyl ether, diepoxides based on amine peroxide resins, diepoxides based on diglycidyl esters, and mixtures thereof.

5. The molding composition according to one of claims 1 or 2, wherein the additive having a branching and/or polymer chain extending action is at least one member selected from the group consisting of diglycidyl ethers based on bisphenol A and epichlorohydrin, amine epoxide resins based on aniline and epichlorohydrin, diglycidyl esters based on cycloaliphatic dicarboxylic acids and epichlorohydrin, and mixtures thereof.

6. The molding composition according to one of claims 1 or 2, wherein the rubber-elastic polymer is selected from the group consisting of EPM, EPDM and copolymers of EPD and EPDM.

7. A process for the production of molded articles by injection molding, gas injection, extrusion, extrusion blow molding or extrusion suction, including the molding composition of one of claims 1 or 2.

8. A process for welding extruded or injection molded parts by the hot element, heat seal, vibration, high-frequency or laser beam method, including the molding composition of one of claims 1 or 2.

9. The molded articles and thermoplastic semi-finished products produced from molding compositions according to one of claims 1 or 2.

10. A process for making molded articles and thermoplastic semi-finished products for thermoforming, including the molding composition of one of claims 1 or 2.
